(19) United States
(12) Patent Application Publication
(10) Pub. No.: US 2019/0245306 A1
(43) Pub. Date: Aug. 8, 2019

(54) CONNECTOR WITH A CONNECTOR POSITION ASSURANCE DEVICE

(71) Applicant: Delphi Technologies, LLC, Troy, MI (US)

(72) Inventor: Eduardo Diaz Alvarado, Ramos Arizpe (MX)

(21) Appl. No.: 15/891,863

(22) Filed: Feb. 8, 2018

(51) Int. Cl. H01R 13/641; H01R 13/627; H01R 13/639

(52) U.S. Cl. CPC H01R 13/641; H01R 13/6272; H01R 13/639; H01R 13/6275; H01R 13/6273

(57) ABSTRACT

A connector assembly is provided with a connector body that is configured to be removably connected with a corresponding mating connector body. The connector body has a deflectable latching member configured to secure the connector body to the corresponding mating connector body. The connector assembly also includes a connector position assurance (CPA) device that is slideably attached to the connector body and is moveable from a pre-staged position that allows the latching member to be deflected to a full-staged position that inhibits deflection of the latching member. The latching member defines a first window and a second window. A first portion of the CPA device is visible in the first window when the CPA device is in the pre-staged position and a second portion of the CPA device is visible in the second window when the CPA device is in the full-staged position.

### TECHNICAL FIELD OF THE INVENTION

The invention relates to connectors, particularly connectors including a connector position assurance device.

### BRIEF DESCRIPTION OF THE SEVERAL VIEWS OF THE DRAWING

The present invention will now be described, by way of example with reference to the accompanying drawings, in which:

FIG. 1 is perspective view of a connector assembly according to one embodiment of the invention;

FIG. 2 is a top view of the connector system of FIG. 1 with a connector position assurance (CPA) device in a pre-staged position according to one embodiment of the invention; and

FIG. 3 is a top view of the connector system of FIG. 1 with the CPA device in a full-staged position according to one embodiment of the invention; and

### DETAILED DESCRIPTION OF THE INVENTION

Presented herein is a connector assembly having a connector body and a corresponding mating connector body that is configured to mate with the connector body. The connector bodies each contain termination elements or “terminals” for wire electrical cables, fiber optic cables, pneumatic lines, hydraulic lines, etc. The connector body includes a latching member that is configured to secure the connector body to the mating connector body when the connector bodies are fully mated. The connector body also includes a connector position assurance (CPA) device that is moveable from a pre-staged position to a fully-staged position only after the latching member has secured the first connector body to the second connector body. The CPA device is also configured to inhibit actuation of the latching member when it is in the full-staged position, thereby, making inadvertent disconnection of the connector body from the mating connector body less likely. The connector body defines a pair or windows through which a portion of the CPA device may be viewed by an assembly operator. When the CPA device is in the pre-staged position, the CPA may be visible to the operator in a first window but is not visible to the operator in a second window. When the CPA device is in the full-staged position, the CPA device may be visible to the operator in the second window.

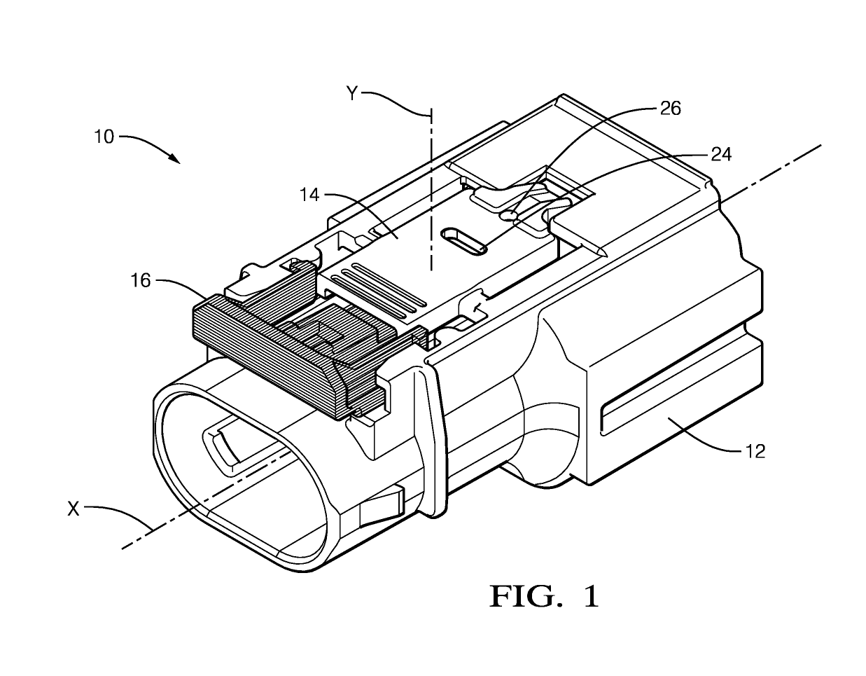

FIGS. 1 through 3 illustrate a non-limiting example of a connector assembly 10. The connector assembly 10 includes a connector body 12 that is configured to be removably connected with a corresponding mating connector body (not shown). The connector body 12 has a deflectable latching member 14 that is configured to secure the connector body 12 to the corresponding mating connector body. The design and operation of latching members for connector assemblies are well known to those skilled in the art.

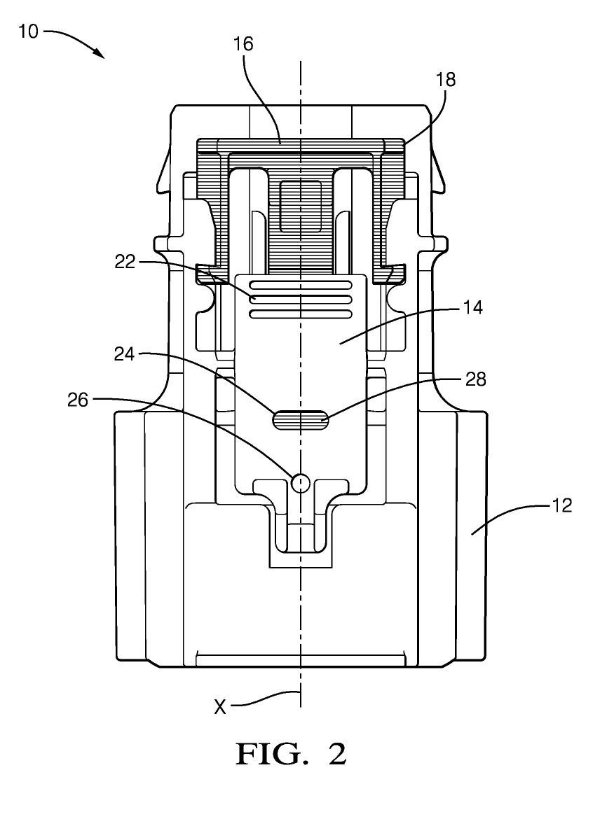

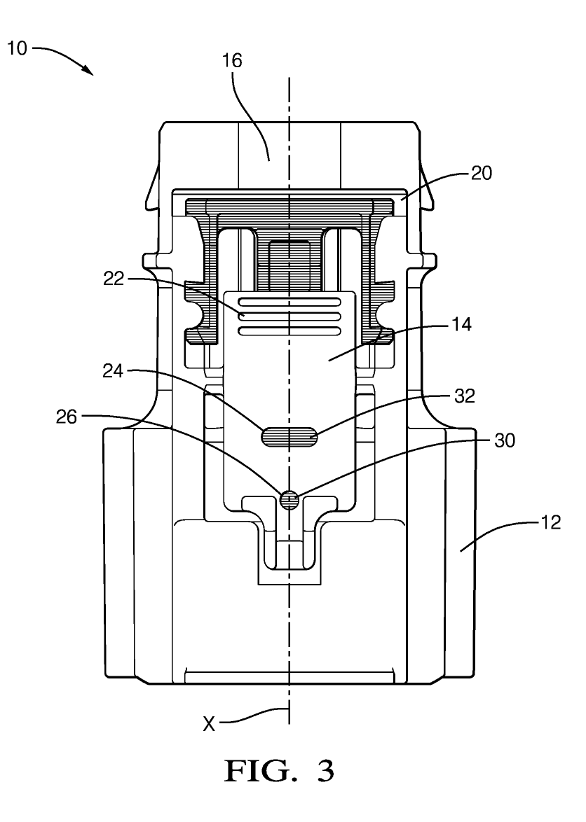

The connector assembly 10 also includes a CPA device 16 that is slideably attached to the connector body 12. The CPA device 16 is moveable from a pre-staged position 18, shown in FIG. 2, to a full-staged position 20 shown inn FIG. 3. When in the pre-staged position 18, the CPA device 16 allows the latching member 14 to be deflected by engagement with a latching nib (not shown) on the mating connector or by an operator pressing on an end 22 of the latching member 14 to disengage the latching member 14 from the latching nib. When the CPA device 16 is in the full-staged position 20, the CPA device 16 inhibits deflection of the latching member 14, particularly by pressing on the end 22 of the latching member 14. The CPA device 16, the latching member 14, and the connector body 12 are configured to inhibit movement of the CPA device 16 from the pre-staged position 18 to the full-staged position 20 until the connector body 12 is fully mated with the mating connector body and the latching member 14 has lockingly engaged the latching nib of the mating connector body.

As shown in FIGS. 2 and 3, the latching member 14 defines a first pre-staged window 24 and a second full-staged window 26 separate from the pre-staged window 24 and forward of the pre-staged window 24 along a longitudinal mating axis X of the connector body 12. Portions of the CPA device 16 may be visible through one or both of these windows 24, 26 when the latching member 14 is viewed along a lateral axis Y that is generally perpendicular to the longitudinal axis X. As used herein, generally perpendicular means±45° of absolutely perpendicular.

As illustrated in FIG. 2, a portion 28 of the CPA device 16 is visible in the pre-staged window 24 and the CPA device 16 is not visible in the full-staged window 26 when the CPA device 16 is in the pre-staged position 18.

When the CPA device 16 is moved along the longitudinal axis X from the pre-staged position 18 to the full-staged position 20, a portion 30 of the CPA device 16 is now visible in the full-staged window 26 as shown in FIG. 3. Another portion 32 of the CPA is also visible in the pre-staged window 24. The pre-staged and full-staged windows 24, 26 are configured to provide the assembly operator with visible confirmation that the CPA device 16 is in the pre-staged or in the full-staged position 20.

As seen in FIGS. 2 and 3, the pre-staged and full-staged windows 24, 26 have different shapes, in this particular example, the pre-staged window 24 has an oval shape and the full-staged window 26 has a round shape. The difference in shapes of the pre-staged and full-staged windows 24, 26 may help the operator distinguish between the pre-staged and full-staged positions of the CPA device 16. As can further be seen in FIGS. 2 and 3, the CPA device 16 and the latching member 14 are different colors, preferably different colors with high contrast. This feature may further help the operator distinguish between the pre-staged and full-staged positions of the CPA device 16.

Accordingly, a connector assembly 10 is provided. The latching member 14 of the connector body 12 includes a pair of windows 24, 26 that allow an operator to view a portion 28, 30, 32 of the CPA device 16 allowing visual conformation whether the CPA device 16 is in the pre-staged position 18 or the full-staged position 20. This confirmation of CPA device 16 position may improve the quality of connection between the connector body 12 and the mating connector body.

The example presented herein is directed to an electrical connector assembly, however other embodiments may be envisioned that are adapted for use with optical cables or hybrid connectors including both electrical and optical cable connections. Yet other embodiments of the connector system may be envisioned that are configured to interconnect pneumatic or hydraulic lines.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments, and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

In the following claims, the terms “including” and “in which” are used as the plain-English equivalents of the respective terms “comprising” and “wherein.” Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items. Additionally, directional terms such as upper, lower, etc. do not denote any particular orientation, but rather the terms upper, lower, etc. are used to distinguish one element from another and locational establish a relationship between the various elements.

1. A connector assembly, comprising:
a connector body;
a corresponding mating connector body configured to be removably connected with the connector body, wherein the connector body has a deflectable latching member configured to secure the connector body to the corresponding mating connector body and wherein the latching member defines a first window and a second window distinct from the first window; and
a connector position assurance (CPA) device slideably attached to the connector body and moveable from a pre-staged position that allows the latching member to be deflected to a full-staged position that inhibits deflection of the latching member, wherein a first portion of the CPA device is visible in the first window when the CPA device is in the pre-staged position, and wherein a second portion of the CPA device is visible in the second window when the CPA device is in the full-staged position.

2. The connector assembly according to claim 1, wherein a third portion of the CPA device is visible in the first window when the CPA device is in the full-staged position.

3. The connector assembly according to claim 2, wherein the first portion of the CPA device and the second portion of the CPA device are the same portion.

4. The connector assembly according to claim 1, wherein the first window and the second window have different shapes.

5. The connector assembly according to claim 1, wherein the CPA device and the latching member are different colors.

6. The connector assembly according to claim 1, wherein, when the CPA device is in the pre-staged position and when the connector body is viewed along a lateral axis that is substantially perpendicular to a longitudinal mating axis of the connector body, the first portion of the CPA device is visible in the first window and the first portion of the CPA is not visible in the second window.

7. A method for operating a connector assembly, comprising the steps of:
providing a connector body;
providing a corresponding mating connector body configured to be removably connected with the connector body, wherein the connector body has a deflectable latching member configured to secure the connector body to the corresponding mating connector body and wherein the latching member defines a first window and a second window distinct from the first window; and
providing a connector position assurance (CPA) device;
slideably attaching the CPA device to the connector body; and
moving the CPA device from a pre-staged position that allows the latching member to be deflected to a full-staged position that inhibits deflection of the latching member, wherein a first portion of the CPA device is visible in the first window when the CPA device is in the pre-staged position, and wherein a second portion of the CPA device is visible in the second window when the CPA device is in the full-staged position.

8. The method according to claim 7, wherein a third portion of the CPA device is visible in the first window when the CPA device is in the full-staged position.

9. The method according to claim 8, wherein the first portion of the CPA device and the second portion of the CPA device are the same portion.

10. The method according to claim 7, wherein the first window and the second window have different shapes.

11. The method according to claim 7, wherein the CPA device and the latching member are different colors.

12. The method according to claim 7, wherein, when the CPA device is in the pre-staged position and when the connector body is viewed along a lateral axis that is substantially perpendicular to a longitudinal mating axis of the connector body, the first portion of the CPA device is visible in the first window and the first portion of the CPA is not visible in the second window.

13. A connector assembly, comprising:
a connector body;
a corresponding mating connector body configured to be removably connected with the connector body, wherein the connector body has a deflectable latching member configured to secure the connector body to the corresponding mating connector body; and
a connector position assurance (CPA) device slideably attached to the connector body and moveable from a pre-staged position that allows the latching member to be deflected to a full-staged position that inhibits deflection of the latching member;
a first viewing means configured for visually confirming location of a first portion of the CPA device when the CPA device is in the pre-staged position; and
a second viewing means configured for visually confirming location of a second portion of the CPA device when the CPA device is in the full-staged position.

14. The connector assembly according to claim 13, wherein the first viewing means is configured for visually confirming location of a third portion of the CPA device when the CPA device is in the full-staged position.

15. The connector assembly according to claim 14, wherein the first portion of the CPA device and the second portion of the CPA device are the same portion.

16. The connector assembly according to claim 13, wherein the first viewing means and the second viewing means have different shapes.

17. The connector assembly according to claim 13, wherein the CPA device and the latching member are different colors.

18. The connector assembly according to claim 13, wherein, when the CPA device is in the pre-staged position and when the connector body is viewed along a lateral axis that is substantially perpendicular to a longitudinal mating axis of the connector body, the first portion of the CPA device is visible via the first viewing means and the first portion of the CPA is not visible via the second viewing means.
